(19) United States
(12) Patent Application Publication
(10) Pub. No.: US 2019/0096007 A1
(43) Pub. Date: Mar. 28, 2019

(54) RECOMMENDING CONNECTION PATHS TO DECISION MAKERS FROM PROFESSIONAL SOCIAL NETWORKS

(71) Applicant: Linkedln Corporation, Sunnyvale, CA (US)

(72) Inventors: Jun Xie, San Jose, CA (US); Badrul Sarwar, San Jose, CA (US); Jonathan Weindel, Redwood City, CA (US); Craig Martell, San Juan Bautista, CA (US)

(21) Appl. No.: 15/714,640

(22) Filed: Sep. 25, 2017

(51) Int. Cl. G06Q 50/00; G06Q 30/02; G06F 17/30

(52) U.S. Cl. CPC G06Q 50/01; G06F 17/30864; G06Q 30/0201

(57) ABSTRACT

Techniques for recommending sales leads from professional social networks using a prospect score (PS) are disclosed. A social networking system identifies a first and second group of members. The system accesses interactions between the first group and second group of members. The system calculates, for each member in the first group, a decision maker score (DMS), relationship score (RS), and social score (SS), the RS and SS values being based on the interactions. The system calculates, for each pair of members in the second group and first group, a PS based on the DMS, RS, and SS values. The system identifies connection paths between members in the second group and ranked members in the first group, the ranking being based on the PS values. The system recommends connection paths between members in the second group and members in the first group based on the identified connections and the PS values.

### TECHNICAL FIELD

The disclosed example embodiments relate generally to the field of graph data management in social networking systems and, in particular, to determining the importance of particular members in these social networking systems and recommending connection paths to the particular members.

### BACKGROUND

The rise of the computer age has resulted in increased access to personalized services online. As the cost of electronics and networking services drop, many services that were previously provided in person are now provided remotely over the Internet. For example, entertainment has increasingly shifted to the online space with companies such as Netflix and Amazon streaming television shows and movies to members at home. Similarly, electronic mail (e-mail) has reduced the need for letters to be physically delivered instead, messages are sent over networked systems almost instantly. Similarly, online social networking sites allow members to build and maintain personal and business relationships in a much more comprehensive and manageable manner.

One important application of new computer technologies is improving connections in the world of sales and commerce. Sales professionals (e.g., people or companies that derive their income from selling goods or products to other individuals or companies) rely on finding new customers to grow and develop both their own careers and the companies that they work for. However, once a new potential customer organization is identified, it can be very difficult to determine a specific, person within the organization to contact ideally, people interested in affecting the actions of organizations attempt to talk to the most influential persons within that organization.

However, if can be difficult to evaluate a particular person's level of influence in an organization. Traditional analysis of influence in an organization has relied on seniority and job title, both of which are indirect measures and poor indicators of true influence in an organization. Networked computer systems can collect and process large amounts of data to streamline and enhance the system for evaluating the influence of a member of an organization.

### DESCRIPTION OF THE DRAWINGS

Some embodiments are illustrated by way of example and not limitation in the figures of the accompanying drawings in which:

FIG. 1 is a network diagram depicting a client-server system that includes various functional components of a social networking system, according to various embodiments;

FIG. 2 is a block diagram of functional components of a professional social network, according to various embodiments;

FIG. 3 is a block diagram illustrating recommendation of a prospect based on a prospect score (PS), according to various embodiments;

FIG. 4 is another block diagram illustrating recommendation of a prospect based on a PS, according to various embodiments;

FIG. 5 is a user interface diagram illustrating an example of a user interface or web page that presents lead recommendations based on prospect scores at a social networking system, according to various embodiments;

FIG. 6 is a user interface diagram illustrating an example of a user interface or web page that presents connections based on a best-in-path module at a social networking system, according to various embodiments;

FIG. 7 is a user interface diagram illustrating an example of a user interface or web page that presents lead recommendations based on a lead recommendation module at a social networking system, according to various embodiments;

FIG. 8 is a flow diagram illustrating a method for using a prospect score (PS) to recommend preferred prospects within an organization to sales representatives at a social networking system, according to various embodiments;

FIG. 9 is a block diagram illustrating a representative software architecture, which may be used in conjunction with various hardware architectures herein described; and

FIG. 10 is a block diagram illustrating components of a machine, according to some example embodiments, able to read instructions from a machine-readable medium (e.g., a machine-readable storage medium) and perform any one or more of the methodologies discussed herein.

### DETAILED DESCRIPTION

The present disclosure describes methods, systems, and computer program products for using a Prospect Score (PS) to recommend preferred prospects within a given organization (e.g., a company) to sales representatives (e.g., sales personnel). Example solutions provide prospect recommendations as a best-path-in for a sales representative based on PS values. In some embodiments, the PS for a given prospect is measured with three components or perspectives: a relationship score (RS), a decision maker score (DMS), and a social score (SS). Example solutions use a DMS in combination with the PS. The PS is a personalized metric that reflects the most valuable prospects for a given sales representative. The PS measures leverage capability of prospects for a specific sales representative based on both static profile information and dynamic social activity.

Certain embodiments use DMS values in conjunction with PS values. In alternative or additional embodiments, PS values for sales prospects (e.g., members of a professional social network) are measured based in part on the respective DMS values for the sales prospects. A DMS is a global measurement of influence of members of a professional social network (e.g., LinkedIn), focusing on the member's seniority, title, and connections' seniority. A DMS for a member is based at least in part on the member's title or other indications of the member's power or influence in a target organization (e.g., a company that is targeted by a sales representative).

Systems and methods disclosed herein identify a best-path-in for a sales representative to a sales prospect at an organization (e.g., a sales lead who is a decision maker at a company). The systems and methods take into account relationships a given sales representative has to decision maker (e.g., network density commonalities). In embodiments, such relationships and network densities contribute to a RS measuring a relative strength of a relationship between the sales representative and the decision maker. According to embodiments, a PS for the decision maker considers the RS along with a SS value for social connections between the sales representative and the decision maker.

Some embodiments provide recommended business leads to users in a user interface, such as, for example, a user interface of a sales navigator tool. Certain embodiments blend two models to recommend sales prospects by using information based on a target organization (e.g., a company targeted by a sales representative) and a PS that looks at connection score between the sales representative the target organization. In some embodiments, sales prospects or leads are recommended based on a SS, a RS, and a DMS, where the DMS is a first level score that forms part of the prospects' PS. For example when searching for sales prospects from amongst a group of members of professional social network, certain embodiments use a DMS for an initial score for the members in the group, and instead of designating members with high DMS values as potential leads for lead recommendation, an overall PS of the members is used to sort the members and to provide lead recommendations.

In the following description, for purposes of explanation, numerous specific details are set forth to provide a thorough understanding of the various aspects of different example embodiments. It will be evident, however, to one skilled in the relevant art(s) that any particular example embodiment may be practiced without all of the specific details and/or with variations, permutations, and combinations of the various features and elements described herein.

### Example Systems

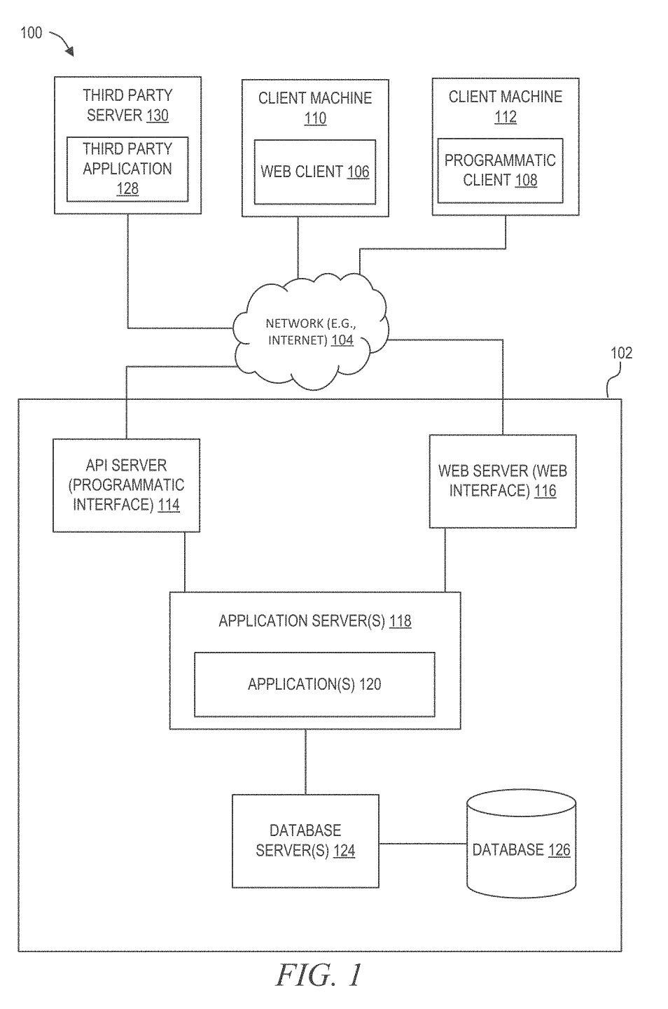

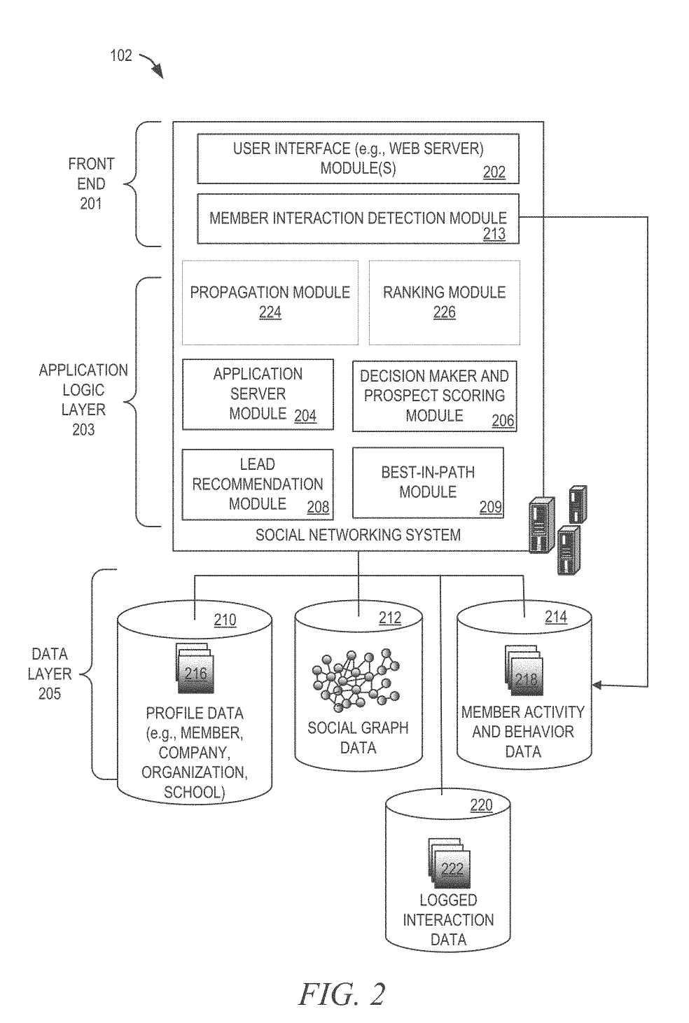

FIG. 1 is a block diagram illustrating a client-server system 100, in accordance with an example embodiment. A networked system 102 provides server-side functionality via a network 104 (e.g., the Internet or a Wide Area Network. (WAN)) to one or more clients. FIG. 1 illustrates, for example, a web client 106 (e.g., a browser) and a programmatic client 108 executing on respective client machines 110 and 112. In some embodiments, the networked system 102 may comprise functional components of a professional social network. For instance, the networked system 102 may comprise the components of a social networking system (see, e.g., FIG. 2). In additional or alternative embodiments, the networked system 102 can host a tool, such as a sales navigator tool, used to produce a PS value for each pair of sales professionals and prospects.

An application programming interface (API) server 114 and a web server 116 are coupled to, and provide programmatic and web interfaces respectively to, one or more application servers 118. The application servers 118 host one or more applications 120. The application servers 118 are, in turn, shown to be coupled to one or more database servers 124 that facilitate access to one or more databases 126. While the applications 120 are shown in FIG. 1 to form part of the networked system 102, it will be appreciated that, in alternative embodiments, the applications 1.20 may form part of a service that is separate and distinct from the networked system 102.11n some embodiments, the application servers 118 include one or more modules (e.g., the application server module 204, decision maker and prospect scoring module 206, lead recommendation module 208, best-in-path module 209, propagation module 224, and ranking module 226 shown in FIG. 2). However, it is to be understood that the modules can be implemented by any component(s) of the networked system 102. It is also to be understood that a portion of the modules 204 206, 208, 209, 224, 226 can be implemented by any component(s) of the networked system 102.

Further, while the system 100 shown in FIG. 1 employs a client-server architecture, the present disclosure is of course not limited to such an architecture, and could equally well find application in a distributed, or peer-to-peer, architecture system, for example. The various applications 120 could also be implemented as standalone software programs, which do not necessarily have networking capabilities.

The web client 106 accesses the various applications 120 via the web interface supported by the web server 116. Similarly, the programmatic client 108 accesses the various services and functions provided by the applications 120 via the programmatic interface provided by the API server 114.

FIG. 1 also illustrates a third-party application 128, executing on a third-party server machine 130, as having programmatic access to the networked system 102 via the programmatic interface provided by the API server 114. For example, the third-party application 128 may, utilizing information retrieved from the networked system 102, support one or more features or functions on a website hosted by a third party. The third-party website may, for example, provide one or more functions that are supported by the relevant applications of the networked system 102.

In some embodiments, any website referred to herein may comprise online content that may be rendered on a variety of devices including, but not limited to, a desktop personal computer (PC), a laptop, and a mobile device (e.g., a tablet computer, smartphone, etc.). In this respect, any of these devices may be employed by a user to use the features of the present disclosure. In some embodiments, a user can use a mobile app on a mobile device (e.g., any of the client machines 110, 112 and the third-party server machine 130 may be a mobile device) to access and browse online content, such as any of the online content disclosed herein. A mobile server (e.g., the API server 114) may communicate with the mobile app and the application server(s) 118 in order to make the features of the present disclosure available on the mobile device.

FIG. 2 is a block diagram showing functional components of a professional social network within the networked system 102, in accordance with an example embodiment. In particular, FIG. 2 is a block diagram showing the functional components of a professional social networking service, which can be hosted on a social networking system 102. As shown in FIG. 2, the social networking system 102 can include data processing modules referred to herein as an application server module 204, a decision maker and prospect scoring module 206, a lead recommendation module 208, a best-in-path module 209, a propagation module 224, and a ranking module 226. These modules may be used to generate and provide best-in-path lead recommendations to sales representatives and other users based on PS values of leads. In some embodiments, the application server module 204, decision maker and prospect scoring module 206, lead recommendation module 208, best-in-path module 209, propagation module 224, and ranking module 226 may reside on the application server(s) 118 in FIG. 1. However, it is contemplated that other configurations are also within the scope of the present disclosure.

As shown in FIG. 2, the professional social network may be based on a three-tiered architecture, consisting of a front-end layer 201, an application logic layer 203, and a data layer 205. In some embodiments, the modules and systems shown in FIG. 2 represent a set of executable software instructions and the corresponding hardware (e.g., memory and processor) for executing the instructions. To avoid obscuring the inventive subject matter with unnecessary detail, various functional modules and systems that are not germane to conveying an understanding of the inventive subject matter have been omitted from FIG. 2. However, one skilled in the art will readily recognize that various additional functional modules and systems may be used with a professional social network, such as that illustrated in FIG. 2, to facilitate additional functionality that is not specifically described herein. Furthermore, the various functional modules and systems depicted in FIG. 2 may reside on a single server computer, or may be distributed across several server computers in various arrangements. Moreover, although a professional social network is depicted in FIG. 2 as a three-tiered architecture, the inventive subject matter is by no means limited to such architecture. It is contemplated that other types of architecture are within the scope of the present disclosure.

As shown in FIG. 2, in some embodiments, the front-end layer 201 comprises a user interface module (e.g., a web server) 202, which receives requests and inputs from various client-computing devices, and communicates appropriate responses to the requesting client devices. For example, the user interface module(s) 202 may receive requests in the form of Hypertext Transfer Protocol (HTTP) requests, or other web-based API requests. Also, for example, the user interface module(s) 202 may receive, from client devices, requests for sales lead recommendations from sales agents and requests to present recommended sales leads (i.e., ranked by PS values for pairs of sales agents and prospects). The responses to such requests (e.g., a ranked list based on PS values) may be transmitted by the professional social network within the networked system 102 to the requesting client devices for display by the client devices. In addition, a member interaction detection module 213 may be provided to detect various interactions that members have with different applications 120, services, and content presented. As shown in FIG. 2, upon detecting a particular interaction, the member interaction detection module 213 logs the interaction, including the type of interaction and any metadata relating to the interaction, in a member activity and behavior database 214.

In some embodiments, the application logic layer 203 may include various modules. In the example of FIG. 2, the modules may include the application server module 204, the decision maker and prospect scoring module 206, the lead recommendation module 208, the best-in-path module 209, the propagation module 224, and the ranking module 226, which, in conjunction with the user interface module(s) 202, generate various user interfaces (e.g., web pages) with data retrieved from various data sources in the data layer 205. In some embodiments, individual application server modules 204 are used to implement the functionality associated with various services and features of the professional social network. For instance, the ability of an organization to establish a presence in a social graph of the social network service, including the ability to establish a customized web page on behalf of an organization, and to publish messages or status updates on behalf of an organization, may be services implemented in independent application server modules 204. Similarly, a variety of other applications or services that are made available to members of the social network service may be embodied in their own application server modules 204. According to an embodiment, a member selection application or module may be embodied in one such application server module 204. In this embodiment, the member selection module may be used for selecting a first group of members (e.g., sales prospects) and a second group of members (e.g., sales professionals) from a profile database 210 in the data layer 205.

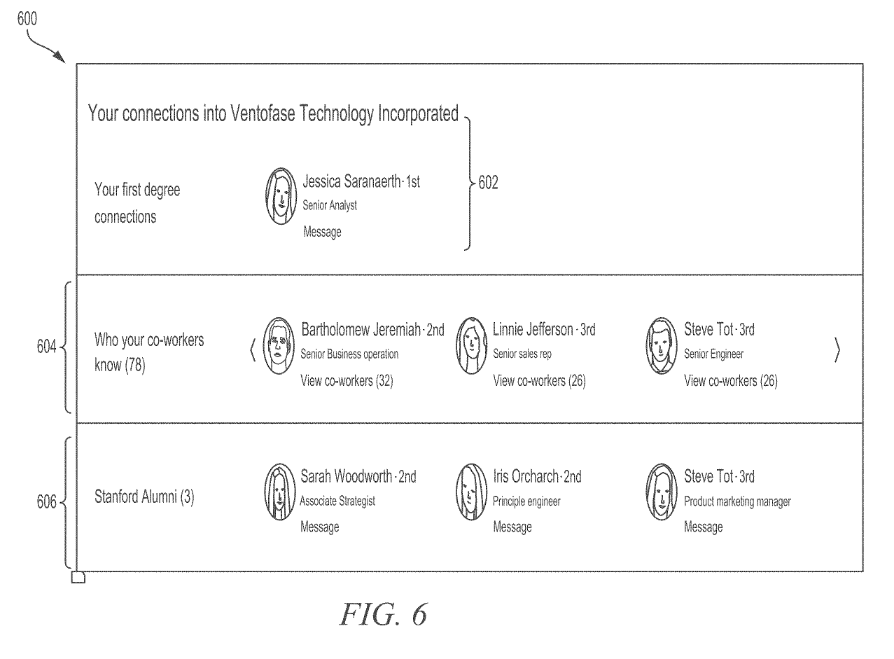

Generally, the decision maker and prospect scoring module 206 calculates DMS, RS, and SS values. Then, the decision maker and prospect scoring module 206 builds a model upon these three metrics with a logistic regression algorithm. That model is then used by the decision maker and prospect scoring module 206 to produce values for the PS metric for each pair of sales professionals and prospects. The PS values can then be used by the ranking module 226 to rank the prospects for a given sales professional. The ranked prospects can then be used by the lead recommendation module 208 to recommend highly-ranked prospects to the sales professional. In some embodiments, as shown in the example user interface of FIG. 6, discussed below, some of the recommendations can be presented as best-in-path connections by the best-in-path module 209.

In embodiments, the decision maker and prospect scoring module 206 determines PS values and DMS values for a plurality of members of a professional social network hosted by the social networking system 102.

The best-in-path module 209 identifies a best-path-in for a sales representative to a sales prospect at an organization (e.g., a sales lead who is a decision maker at a company). The modules of the social networking system 102 take into account relationships a given sales representative has to decision maker (e.g., network density commonalities). In embodiments, such relationships and network densities contribute to a RS measuring a relative strength of a relationship between the sales representative and the decision maker. According to embodiments, a PS for the decision maker calculated by the decision maker and prospect scoring module 206 considers the RS along with a SS value for social connections between the sales representative and the decision maker.

In some embodiments, the lead recommendation module 208 provides recommended business leads to users in a user interface, such as, for example, a user interface of a sales navigator tool. Certain embodiments of the lead recommendation module 208 blends two models to recommend sales prospects by using information based on a target organization (e.g., a company targeted by a sales representative) and a PS that looks at connection score between the sales representative the target organization. In some embodiments, sales prospects or leads are recommended by the lead recommendation module 208 based on a SS, a RS, and a DMS, where the DMS is a first level score that forms part of the prospects' PS. For example when searching for sales prospects from amongst a group of members of professional social network, certain embodiments use a DMS calculated by the decision maker and prospect scoring module 206 for an initial score for the members in the group, and instead of designating members with high DMS values as potential leads for lead recommendation, an overall PS for each of the members is produced by the decision maker and prospect scoring module 206. This PS is used by the ranking module 226 to sort the members into a ranked list. The top-ranked members of the ranked list are then presented by the lead recommendation module 208 to provide lead recommendations.

Given a sales representative and a target organization (e.g., a company the sales representative is interested in), embodiments derive a PS as a personalized metric upon which a tool, such as, for example, a sales navigator tool, to recommend the most effective connection path for the sales representative to win business opportunities in the given organization. The recommendation will let the sales representative know who within the organization the sales representative should focus on in that organization in order to maximize opportunities. In the example of FIG. 2, the tool can invoke the decision maker and prospect scoring module 206 to derive the PS, and then invoke the lead recommendation module 208 and the best-in-path module 209 to recommend the most effective connection path for the sales representative to win business opportunities in the organization.

In a given social network, such as, for example, a professional social network hosted on the social networking system 102, it can be important to identify members with the most influence or the ability to make decisions that affect the actions of organizations the members are affiliated with. Specifically, when a sales professional wants to sell a product or service to an organization (e.g., any group of individuals including companies, non-governmental organizations, government organizations, religious groups, interest groups, and so on), it is often unclear which specific individuals within the organization actually make decisions about purchases. Indeed, for large organizations, decisions are made by a large number of different people, each of which has specific areas for which they are responsible.

One way of measuring decision maker status is to track a variety of data points for each member in the group of members being evaluated (e.g., all the employees of a given organization) and to use a classifier to generate a DMS. In some example embodiments, the DMS generated by the decision maker and prospect scoring module 206 is based on the number of messages the member receives (especially from sales representatives or sales personnel), the number of personal contacts, the number of people who have saved that person as a sales lead, and so on. Using these data points the social networking system can establish a starting point DMS for each member in the first group of members.

Once the decision maker and prospect scoring module 206 determines initial DMS values for a group of members, the social networking system 102 identifies a first group of members and a second group of members. In general, the first group of members are members who are potential decision makers within an organization. These members can be conceptualized as potential sales leads or sales prospects. En some example embodiments, this first group is determined based on the employment history of members of the social networking system. For example, members in the group who have certain titles are considered. In other example embodiments, all members are considered who are currently associated with a specific organization or set of organizations (or any organization if the decision maker and prospect scoring module 206 needs to generate DMS values for all the members of the social networking system 102).

The second group of members are generally sales personnel or sales representatives. In some example embodiments, the social networking system 102 determines sales personnel based on their use of a sales enabling service of the social networking system. In some example embodiments, a member may be in the first group in some circumstances (e.g., when they are likely to act as a buyer) but in the second group in others (e.g., when they are likely to act as a seller). In other example embodiments, a member maybe grouped into both groups simultaneously (e.g., in cases where they may act as both a buyer and a seller or when the whole social network system is being evaluated simultaneously).

In sonic example embodiments, the social networking system 102 then identifies a plurality of interactions between the two groups. In some example embodiments, the interactions are stored in a logged interaction data repository 220, which includes logged interaction data 222. Such interactions may include messages (e.g., in-system messages, entails, texts, voice mails, and so on), connections, profile views, sales transactions, invitations, lead saves, and so on. In some example embodiments, the interactions are bidirectional (e.g., messages between two members), unidirectional (e.g. a profile view), or non-directional (e.g., a connection between members).

In certain embodiments, the social networking system 102 invokes the decision maker and prospect scoring module 206 to create PS values as personalized metrics, which differ from DMS values that are a global measurement of influence of members of the social networking system. That is, DMS values focus on the members' seniority, title, and seniority of the members' connections. A DMS value is a global metric that measures the possibility of a member to be a decision maker within an organization (e.g., a company the member is employed by or associated with). For example, a DMS value for a given member will be same for that member regardless of which sales personnel or sales representatives that contact the member. That is, the member will have the same level of influence or decision making authority in the organization without regard to the particular sales representative who attempts to connect to the member. This is because that member's DMS value is a global metric focused on features and attributes specific to that member, and is not focused on features of any sales personnel.

In contrast to DMS values, PS values are designed to reflect the most valuable prospects for a specific, given sales representative. For instance, given a sales representative and an organization (e.g., a company targeted by the sales representative), embodiments recommend for the sales representative the top K prospects within that organization based on the PS metric.

In some example embodiments, as DMS values are propagated, by the propagation module 224, throughout a group of members of a professional social network. Member-specific information, such as title, seniority, job history, are taken into account by the decision maker and prospect scoring module 206 to adjust DMS values higher or lower. In certain embodiments, a number of subgraphs are created by the decision maker and prospect scoring module 206, each subgraph representing one type of interaction (e.g., messages, views, likes, follows, and invitations). Steady-state DMS values are determined by the decision maker and prospect scoring module 206 for each graph; then the separate graphs are assigned a weight and the DMS values are combined into a single graph-derived DMS. In some example embodiments, the graph-derived DMS is weighted and combined with other measures of member relevance to a particular sales person. Thus, when a sales member accesses a list of members associated with a particular organization, the members are shown in particular order, the particular order at least partially determined by the graph-derived DMS.

According to some embodiments, a PS value generated by the decision maker and prospect scoring module 205 is an essential measurement of leverage capability of sales prospects for a specific sales representative. The leveragability may be measured based on both static member profile information and dynamic social activity of members. The static measurement may include information from the prospects' profiles and common-factors between the profiles of the sales representative and the prospects. The profile information may be modeled by the DMS. A PS value may also be based on a RS value that measures relationships that exist between the sales representative and the prospect. The RS value poses insights discovered by analysis showing that the members with higher common properties with other members have the higher possibility to build tight connections with those other members. Examples of such common properties can include common education (e.g., attended the same university) and shared, common career connections (e.g., worked at the same organizations or companies).

In some embodiments, dynamic social activity is computed by the decision maker and prospect scoring module 206 based on the social interaction between the sales representative and the prospect, including the feed engagement, communication, and page views. For example, the PS for a given member, identified by a unique memberID, may be computed by the decision maker and prospect scoring module 206 based on the following three metrics: DMS: [memberID, score]; RS: [sales representative, memberID, score]; and SS [RS multiplied by a number of connections the sales representative has]. By computing a PS based on the DMS, RS, and SS values, embodiments identify a decision maker at an organization who represents a best-path-in for a sales representative that is targeting that organization. Besides being used to determine a best-path-in, the PS can also be used to provide results of a lead search and other use cases in a tool such as a sales navigator tool.

In some embodiments, communications sent via the social networking system 102 from a sales representative to their leads (e.g., members of a professional social network associated with sales accounts) are used as an objective measure. These example embodiments formulate the problem as a classification problem to predict whether sales representatives will send such in-system messages or communications (e.g., InMail messages sent via LinkedIn) to the recommended prospects in the next K days. In certain embodiments, three first-level models (e.g., DMS, RS, and SS) are trained using various features.

In example embodiments, the following features or member attributes are used by the decision maker and prospect scoring module 206 to determine the DMS for a member of a professional social network:

1.) Position/experience (higher DMS values are assigned to more experienced members based on the assumption that more influential decision makers are typically more senior and/or hold higher positions in an organization/industry);

2.) Seniority in the organization (e.g., a company) and the related industry;

3.) Connectivity (higher DMS values are assigned to better-connected members based on the assumption that more influential decision makers are typically better connected with other senior people and decision makers in the arganization/industry);
a. Connections with senior people within the same organization and related industries;
b. Connections with sales professionals;

4.) Behavioral (assumption: more influential decision makers are often more viewed, sent more invites, saved as leads, and sent communications by sales professionals);
a. Profile views (e.g., a number of profile views of the member's professional social network profile);
b. Connection invites (e.g., invitations sent via a professional social network);
c. Lead saves; and
d. Communications received via a professional social network (e.g., InMail messages received via LinkedIn).

For the RS values, several features are used by the decision maker and prospect scoring module 206 to measure commonalities between a sales professional and a prospect. The majority of the features listed below are bi-directional commonalities between a sales professional and a prospect. For example, a same school feature or flag refers to a sales professional and prospect attending the same school (e.g., secondary school, undergraduate university, or graduate school) at some point. Some features have a time component. For example, an overlap school feature or flag refers to a sales professional and prospect attending the same school at the same time. Some features are specific to an individual, like the social selling index (SSI) score of a prospect. Existence of these features (e.g., school commonalities between a sales professional and a prospect) increase an RS value for the prospect. That is, higher RS values are assigned to prospects with more features in common with a sales professional based on the assumption that prospects with more overlaps or commonalities with the sales professional arc more likely to have a relationship with the sales professional. In example embodiments, the following features or attributes are used to by the decision maker and prospect scoring module 206 to determine the RS for a member of a professional social network:

1.) Education overlap (higher RS values are assigned to members with more similar educational backgrounds based on the assumption that common-properties promote communication):
a. Same school flag
b. Same school and degree flag
c. Same school and field flag
d. Same school & field & degree flag
e. Overlap school flag (same school at the same time)
f. Overlap school field flag (same school at the same time, pursuing a degree in the same field)
g. Number of days attended the same school
h. Same degree flag
i. Same field flag

2.) Career overlap (higher RS values are assigned to members with more similar work histories):
a. Same company flag
b. Same company location flag (working at the same company and the same location at some point in the past)
c. Same title flag
d. Same industry flag
e. Overlap company flag working at the same company at the same time)
f. Count of days worked at same company
g. Count of common skills
h. Number of days worked at same company (how long a prospect and sales professional worked at the same company)

3.) Connection overlap (higher RS values are assigned to members with more similar connection metrics and properties):
a. Number of connections (prospect)
b. Number of connections (sales professional)
c. Number of common connections (first degree)
d. Number of common connections (second degree)
e. Number of connections (sender)
f. Number of connections (receiver)
g. Number of common followed groups
h. Connection communications (e.g., in-system messages such as InMail messages) proposal type

4.) Geographic overlap (higher RS values are assigned to members with more similar geographic properties):
a. Same state/province flag
b. Same postal code (e.g., zip code) flag

5.) Social selling index (SSI) features:
a. SSI (sales professional)
b. SSI Social Brand (sales professional)
c. SSI Right People (sales professional)
d. SSI Insights (sales professional)
e. SSI Relationships (sales professional)
f. SSI (prospect)
g. SSI Social Brand (prospect)
h. SSI Right People (prospect)
i. SSI Insights (prospect)
j. SSI Relationships (prospect)

6.) Behavioural features:
a. Historical response rate over last 12 months (sales professional)
b. Historical Response Rate over last 12 months (prospect)
c. Number of communications (e.g., in-system messages such as InMails) sent over last 12 months (sales professional)
d. Number of communications (e.g., InMails) received over last 12 months (Prospect)
e. Field subscription flag (prospect)
f. Online subscription flag (prospect)
g. Field subscription flag (sales professional)
h. Online Number (sales professional)
i. Number of engagements between prospect and sales professional (likes, comments, shares, posts, poncho posts, etc.)
j. Number of profile views between prospect/sales professional

An SS value for a member of a professional social network may be calculated by the decision maker and prospect scoring module 206 based on measures of social interaction between a sales representative and a prospect. One example measure is a number of connections the member has with other members of the professional social network. In this example, the SS value is merely the number of connections the member has. According to an embodiment, the SS value (e.g., the member's number of connections) may be multiplied by the product of that member's DMS and RS to determine the member's PS.

In additional or alternative embodiments, the SS value may be calculated based on other measures of social interaction between a sales representative and a prospect. Examples of such measures include feed engagement between the sales representative and the prospect, communications exchanged between the sales representative and the prospect (e.g., a count of in-system messages such as InMail messages sent within LinkedIn), and page views. In example embodiments, the following features or attributes are used to determine the feed engagement component of an SS value for a member of the professional social network: feed follow, feed click, feed like, and feed comment. In certain embodiments, a higher SS value is assigned by the decision maker and prospect scoring module 206 to a member (e.g., a sales representative) whose feed has been followed, clicked on, liked, and commented-on by another member (e.g., a prospect) as compared to other members who have lower feed follow, feed click, feed like, and feed comment attributes. This is based on the assumption that a member of the professional social network whose feed is more often clicked on, liked, and commented on typically has a higher level of social interaction with other members of the professional social network.

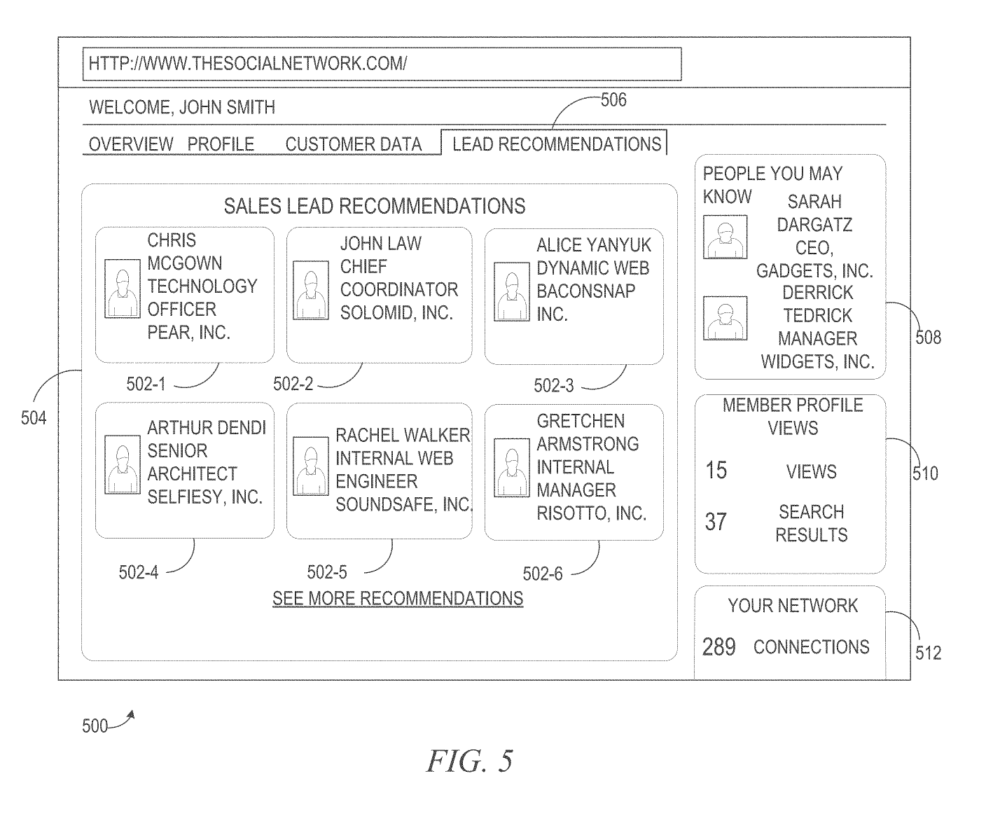

After the DMS, RS, and SS values have been calculated by the decision maker and prospect scoring module 206 based on the above-listed features, a second model is built upon these three metrics with a logistic regression algorithm. That model is then used to produce values for the PS metric for each pair of sales professionals and prospects. The PS values can then he used by a sales tool, such as, for example a sales navigator tool, to rank the prospects for a given sales professional and recommend highly-ranked prospects to the sales professional. As shown in the example user interfaces of FIGS. 5-7, discussed below, such recommendations can be presented in a user interface of the sales tool.

In certain embodiments, the DMS values used by the decision maker and prospect scoring module 206 to produce PS values are initially determined and propagated by the propagation module 224, as described below.

Generally, the propagation module 224 identifies two groups of members, the first group being members who are potential decision makers (e.g., potential prospects or leads) and the second group being sales personnel (e.g., sales representatives). The propagation module 224 then identifies a plurality of interactions between members of the first group and members of the second group. Using this information, the propagation module 224 generates a bipartite graph using the members as nodes (or vertexes) and the interactions as edges.

Each of the members of the first group has an initial DMS value and, in some example embodiments, the members of the second group have an initial score as well. The propagation module 224 then propagates DMS value updates through the graph based on the accessed member interactions. For example, receiving a message from a high DMS member raises the DMS value of the receiving member.

Similarly, if a member has interactions with a low DMS value, the member's DMS value will be reduced. In some example embodiments, the propagation module 224 iterates through each interaction (or conversely, applies them all at once and iterates through the DMS updates) and updates the DMS values for each iteration. Because of the connected nature of the graph, each DMS update has the possibility of affecting every other score.

The propagation module 224 continues to iteratively apply DMS updates until those scores reach a steady state. Once a steady state is reached, the steady state scores are recorded.

In sonic example embodiments, the propagation module 224 generates a plurality of subgraphs. Each subgraph represents a particular type of interaction. For example, one subgraph includes connections (which are directionless) while another represents profile views (which are unidirectional). The propagation module 224 goes through the propagation process for each graph to reach a steady state score for each sub-graph. The sub-graph steady state scores can then be recombined into a single graph-derived steady state score. In some example embodiments, the subgraph steady state scores are weighted when they are combined such that sonic subgraphs have more influence on the final score than other subgraphs.

In sonic example embodiments, the ranking module 226 receives the graph-derived DMS values, the RS values, and the SS values from the propagation module 224. In some example embodiments, the graph-derived DMS is then combined with other indicators of DMS. In some example embodiments, the ranking module 226 also combines the DMS, RS, and SS with other indicators of interest that might apply to a particular sales agent who requests information about members.

For example, a sales agent may be interested in members who have particular characteristics in common with them (e.g., location, experience, past work history, similar education background, connections in common, and so on). The ranking module 226 then ranks each member based on the combined DMS. In some example embodiments, the ranking module 226 selects one or more members based on the rankings. In sonic example embodiments, the selected one or more members are then transmitted to a requesting member for display.

As shown in FIG. 2, the data layer 205 may include several databases, such as the profile database 210 for storing profile data 216, including both member profile attribute data and profile attribute data for various organizations. As shown, the profile data 216 may include attribute data for organizations that are associated with members. In the example of FIG. 2, such organizations may include companies (e.g., previous and current employers), educational organizations (e.g., schools a member has attended or worked for), and other organizations (e.g., government organizations and non-profit organizations).

Consistent with some embodiments, when a person initially registers to become a member of the professional social network, the person will be prompted to provide some profile attribute data, such as his or her name, age (e.g., birthdate), gender, interests, contact information, home town, address, spouse's and/or family members' names, educational background (e.g., schools, majors, matriculation and/or graduation dates, etc.), employment history, skills, professional organizations, and so on. This information may be stored, for example, in the profile data 216. Similarly, when a representative of an organization initially registers the organization with the professional social network, the representative may be prompted to provide certain information about the organization. This information may be stored, for example, in the profile data 216, or another database (not shown). In some embodiments, the profile data 216 may be processed (e.g., in the background or offline) to generate various derived profile data. For example, if a member has provided information about various job titles the member has held with the same company or different companies, and for how long, this information can be used to infer or derive a member profile attribute indicating the member's overall seniority level, or a seniority level within a particular company. In some embodiments, importing or otherwise accessing data from one or more externally hosted data sources may enhance the profile data 216 for both members and organizations. For instance, with companies in particular, financial data may be imported from one or more external data sources, and made part of a company's profile.

The profile data 216 may also include information regarding settings for members of the professional social network. These settings may comprise various categories, including, but not limited to, privacy and communications. Each category may have its own set of settings that a member may control.

Once registered, a member may invite other members, or be invited by other members, to connect via the professional social network. A “connection” may require a bilateral agreement by the members, such that both members acknowledge the establishment of the connection. Similarly, in some embodiments, a member may elect to “follow” another member. In contrast to establishing a connection, the concept of “following” another member typically is a unilateral operation, and at least in some embodiments, does not require acknowledgement or approval by the member who is being followed. When one member follows another, the member who is following may receive status updates or other messages published by the member being followed, or relating to various activities undertaken by the member being followed. Similarly, when a member follows an organization, the member becomes allowed to receive messages or status updates published on behalf of the organization. For instance, messages or status updates published on behalf of an organization that a member is following will appear in the member's personalized data feed or content stream. In any case, the various associations and relationships that the members establish with other members, or with other entities and objects, may be stored and maintained as social graph data within a social graph database 212.

The professional social network may provide a broad range of other applications and services that allow members the opportunity to share and receive information, often customized to the interests of the member. For example, in some embodiments, the professional social network may include a photo sharing application that allows members to upload and share photos with other members. In some embodiments, members may be able to self-organize into groups, or interest groups, organized around subject matter or a topic of interest. In some embodiments, the professional social network may host various job listings providing details of job openings with various organizations.

As members interact with the various applications, services, and content made available via the professional social network, the members' behavior (e.g., content viewed, links or member-interest buttons selected, etc.) may be monitored and information 218 concerning the members' activities and behavior may be stored, for example, as indicated in FIG. 2, by a member activity and behavior database 214. This member activity and behavior database 214 may be used by the decision maker and prospect scoring module 205 to determine DMS and PS values used to rank search results for a lead search query. The information 218 can be used as training data and may comprise professional social network activity of member accounts and employer accounts with respect to one or more job postings. Such professional social network activity includes a member account viewing a job posting(s), an employer account viewing a profile of a member account that is a target candidate account, a member account applying to a job posting, an employer account selecting a member account that applied to a job posting for hire, and an employer account not selecting a member account that applied to a job posting for hire. The data layer 205 hither includes a logged interaction data repository 220, which includes logged interaction data 222 between member accounts. This logged interaction data repository 220 may also be used by one or more of the lead recommendation module 208 and the best-in-path module 209 to determine search results for a lead search query.

In some embodiments, the professional social network provides an API module via which third-party applications can access various services and data provided by the professional social network. For example, using an API, a third-party application may provide a user interface and logic that enables an authorized representative of an organization to publish messages from a third-party application to a content hosting platform of the professional social network that facilitates presentation of activity or content streams maintained and presented by the professional social network. Such third-party applications may be browser-based applications, or may be operating system-specific. In particular, some third-party applications may reside and execute on one or more mobile devices (e.g., a smartphone, or tablet computing device) having a mobile operating system.

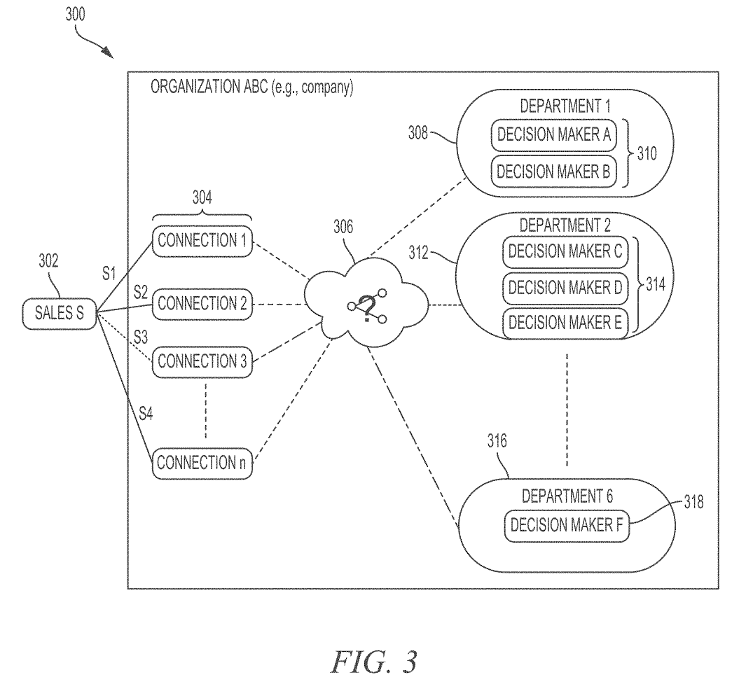

The data in the data layer 205 may be accessed, used, and adjusted by the application server module 204, decision maker and prospect scoring module 206, lead recommendation module 208, best-in-path module 209, propagation module 224, and ranking module 225, as will he described in more detail below in conjunction with FIGS. 3-8. Although the application server module 204, decision maker and prospect scoring module 205, lead recommendation module 208, best-in-path module 209, propagation module 224, and ranking module 226 are referred to herein as being used in the context of a professional social network, it is contemplated that these modules also be employed in the context of any website or online services, including, but not limited to, content-sharing sites (e.g., photo- or video-sharing sites) and any other online services that allow users to have a profile and present themselves or content to other users. Additionally, although features of the present disclosure are referred to herein as being used or presented in the context of a web page, it is contemplated that any user interface view (e.g., a user interface on a mobile device or on desktop software) is within the scope of the present disclosure. It is to be understood that one or more of the application server module 204, the decision maker and prospect scoring module 206, the lead recommendation module 208, the best-in-path module 209, the propagation module 224, and the ranking module 226 can be implemented in one or more of the application servers 118.

Although the application server module 204, the decision maker and prospect scoring module 206, the lead recommendation module 208, the best-in-path module 209, the propagation module 224, and the ranking module 226 are referred to herein as being used in the context of a social networking service, it is contemplated that these modules may also be employed in the context of any website or online services. Additionally, although features of the present disclosure are referred to herein as being used or presented in the context of a web page, it is contemplated that any user interface view (e.g., a user interface on a mobile device or on desktop software) is within the scope of the present disclosure. For example, the user interface views shown in FIGS. 5-7 may be used to present sales lead recommendations to sales representatives based on PS values.

In an example embodiment, when member profiles are indexed, forward search indexes are created and stored. The application server module 204, the decision maker and prospect scoring module 206, the lead recommendation module 208, the best-in-path module 209, the propagation module 224, and the ranking module 226 facilitate the recommendation of prospects based on PS values within the social networking service, such as the indexing and searching for decision maker data or information contained in the data layer 205, such as profile data 216 (stored, e.g., in the profile database 210) social graph data (stored e.g., in the social graph database 212), and member activity and behavior data (stored, e.g., in the member activity and behavior database 214). The application server module 204, the decision maker and prospect scoring module 206, the lead recommendation module 208, the best-in-path module 209, the propagation module 224, and the ranking module 226 may collect, parse, and/or store data (e.g., connection data, best-in-path data, PS values, DMS values, RS values, and SS values) in an index or other similar structure to facilitate the identification and retrieval of lead and connection information in response to received queries for sales prospects. This may include, but is not limited to, forward search indexes, inverted indexes, N-gram indexes, and so on.

As discussed above with regard to the propagation module 224 of FIG. 2, a bipartite graph may be used to iteratively derive a DMS, in accordance with some example embodiments. In accordance with some example embodiments, the graph is based using members from a social networking system (e.g., the social networking system 102 of FIG. 2).

In some example embodiments, the social networking system 102 identifies a first group of members. In some example embodiments, this first group of members are members who are in a position to make decisions within an organization. In some example embodiments, the first member group is determined based on organization hierarchies, member titles, work history, organization sales and purchase records, and so on.

In an example graph, the first member group includes five members: A, B, C, D, and E. In addition, each member in the first member group has an associated initial score. For the first group members, the initial score is an initial DMS that is based on data in the member profile of the member. For example, member A has an initial score of 0.9, member B has an initial score of 0.7, member C has an initial score of 0.6, member D have an initial score of 0.4, and member F has an initial score of 0.1.

The social networking system (e.g., the social networking system 102 in FIG. 2) also identifies a second member group. In some example embodiments, the second member group is comprised of members with a sales related occupation (e.g., sales agents or sales representatives). In this example, the second member group includes five members: H, G, I, J, and K.

In this example, the second group of members (e.g., sales personnel) each have an initial score. For the second group of members, the initial score is a ranking of their importance or influence as a sales person. For example, a member H has an initial score of 0.8, member G has an initial score of 0.5, member I has an initial score of 0.3, member J has an initial score of 0.2, and member K has an initial score of 0.1.

The bipartite graph organizes the members as nodes or vertexes in the bipartite graph. The social networking system (e.g., the social networking system 102 in FIG. 2) also identifies a plurality of interactions between members of the first member group and the second member group. In this case the interactions are unidirectional, like profile views. After a single iteration responding to a single interaction, the bipartite graph described above is updated. For instance, the interaction in this example is a profile view from member A to member I.

In this case, the initial DMS value of member I is adjusted upwards because of the initial DMS value of member A is 0.9 (for a range between 0 and 1.0) is relatively high. The adjusted score is adjusted to a currently adjusted score of 0.4.

In another example, the bipartite graph described above may be further modified after an additional iterative step. In this case, the interactions are profile views from member I to members C and member D.

In response to the DMS value for member I being adjusted up to an adjusted score of 0.4, the DMS value for member C is adjusted up to an adjusted score of 0.65. Similarly, the DMS value for member D is also adjusted up to an adjusted score 0.48. These changes are then propagated forward to other members who have interacted with members C and members D.

In some example embodiments, the interactions are represented as edges in the bipartite graph. In some example embodiments, the social networking system the social networking system 102 in FIG. 2) then uses such a graph to iteratively propagate DMS values though the graph such that interactions with members who have a high initial score will result in a higher adjusted score.

### Example Processes

FIG. 3 is a block diagram illustrating recommendation of a prospect based on a prospect score (PS). In particular, FIG. 3 illustrates a process 300 for recommending decision makers 310, 314, and 318 to a sales agent 302 based on connections 304 the sales agent 302 has to the decision makers 310, 314, and 318. As shown, the process 300 includes the recommendation of a best-path-in to departments 308, 312, and 316 within an organization (e.g., a company with departments 308, 312, and 316). In the example of FIG. 3, the best-path-in is a path via a professional social network 306 to particular decision makers 310, 314, and 318. In this example, the decision makers 310, 314, and 318 are prospects with the highest PS value for the sales agent 302.

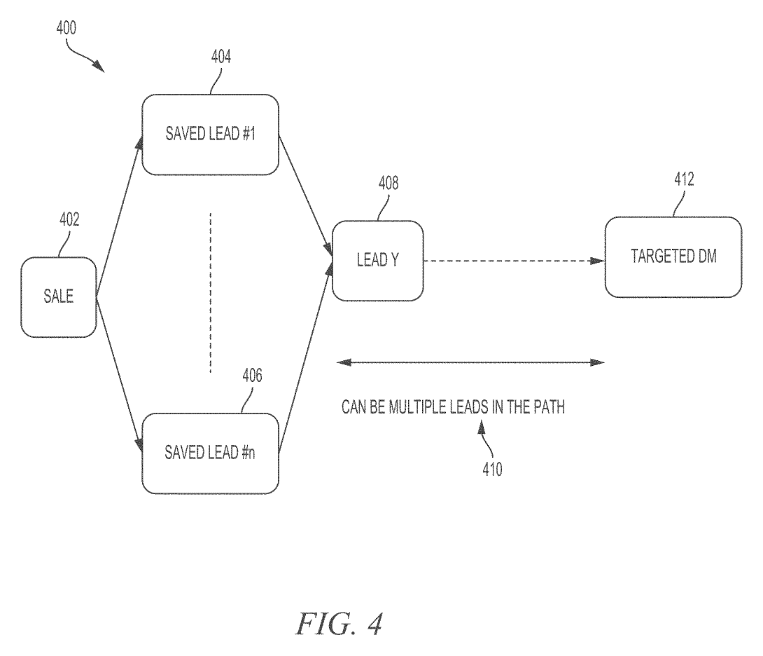

FIG. 4 is a block diagram illustrating recommendation of a prospect based on a PS. In particular, FIG. 4 illustrates a process 400 for recommending a lead 408 to a sales agent 402. As shown, the process 400 includes selecting the lead 408 from amongst a plurality of saved leads (e.g., saved leads 404, 406, and other leads). That is, there can be multiple leads 404, 406, and 408 in a path 410 between the sales agent 402 and a targeted decision maker 412 (i.e., a decision maker at a targeted organization). In FIG. 4, the selected lead 408 is recommended as the prospect with the best-path-in to the targeted decision maker 412 for the sales agent 402. In certain examples, the selected lead 408 has the highest PS value of a plurality of saved leads (e.g., saved leads 404, 406, and other saved leads).

### Example User Interfaces

FIG. 5 is a user interface diagram illustrating an example of a user interface 500 or web page. As shown, a member (e.g., a sales agent or sales representative) has requested to view one or more sales lead recommendations by selecting a lead recommendations tab 506. A sales lead recommendation page 504 is displayed. The sales lead recommendation page 504 includes a plurality of sales lead recommendations 502-1 to 502-6, wherein each sales lead recommendation 502 displays a member name and includes basic information about the member, such as their name, title(s), employer(s), and basic contact information. Members (e.g., sales personnel) can then select particular sales leads to get additional information and the ability to contact the sales lead.

In some example embodiments, the lead recommendations are organized based on a determined PS. In some example embodiments, the PS considers one of many factors, such as, for example a DMS, a RS, and a RS for a lead recommendation, which are used to rank the members. In other example embodiments, the member selects a particular organization (e.g., a company) and the displayed members are ranked by the members' respective PS values from a single organization.

The user interface 500 also includes information in side sections of the interface 500 including a contact recommendation section 508, profile viewership statistic section 510, and a social graph statistic section 512.

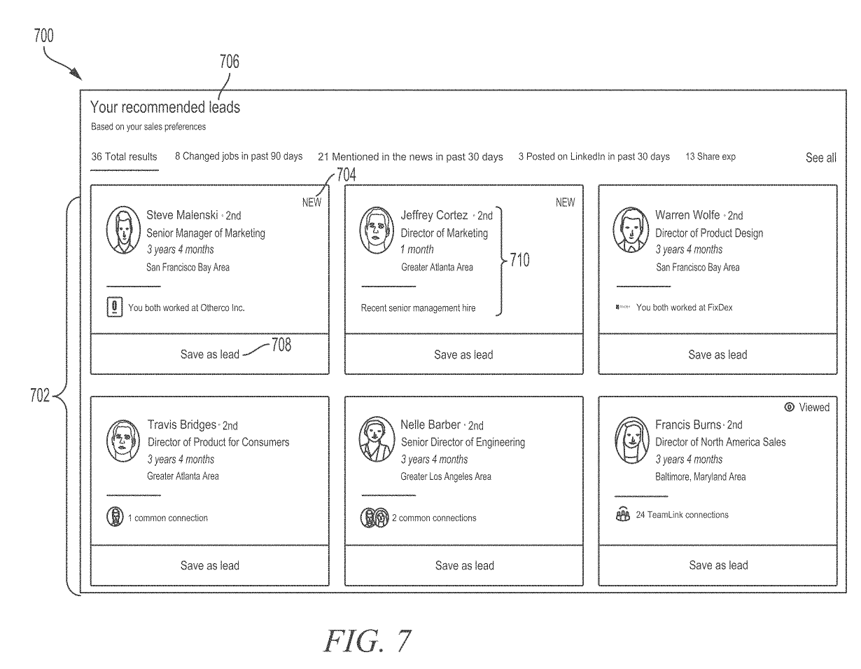

FIGS. 6 and 7 depict user interfaces showing use cases of the PS metric. The user interfaces shown in FIGS. 6 and 7 enable sales personnel users, such as, for example, sales representatives and sales agents, to find types of connections. That is, the example user interfaces of FIGS. 6 and 7 enable users to find sales prospects/sales leads within a certain industry or organization, such as a company. Then, from the displayed, potential sales prospects, the PS metric is used to indicate who is most likely to result in a sales response.

In the example user interfaces of FIGS. 6 and 7, the PS metric is used in a sales navigator tool that provides prospect search capabilities and presents lead recommendations.

In particular, FIG. 6 is a user interface diagram illustrating an example of a user interface 600 or web page that presents connections based on a best-in-path module at a social networking system. As shown in FIG. 6, a member (e.g., a sales agent or sales representative) has requested to view one or more sales lead recommendations at a selected company. The user interface 600 presents output of a best-in-path module, where the output includes a first-degree connection 602, and second- and third-degree connections. As shown in FIG. 6, the second- and third-degree connections include co-worker connections 604 whom the member's co-workers know, and alumni connections 606 who attended the same university as the member.

FIG. 7 is a user interface diagram illustrating an example of a user interface or web page that presents lead recommendations based on a lead recommendation module at a social networking system. In particular, FIG. 7 illustrates an example user interface 700 as a web page that presents output of a lead recommendation module on a home page of a sales navigator tool.

As shown, the user interface 700 displays recommended leads 706 based on sales preferences of a user (e.g., a sales agent or sales representative). In the example of FIG. 7, the recommended leads 706 include a plurality of sorted leads 702. For each of the sorted leads 702, the user interface 700 displays prospect information 710. The prospect information 710 includes a member name, a degree of connection with the user (e.g., first, second, or third-degree), and basic information about the member, such as their title, employer, and connection information (e.g., number of common connections and career overlay information). As shown, for new leads in the sorted leads 702, the user interface 700 displays a new lead indication 704. The user interface 700 also includes a save as lead link 708 that the user may select to save selected ones of the recommended leads 706.

### Example Methods

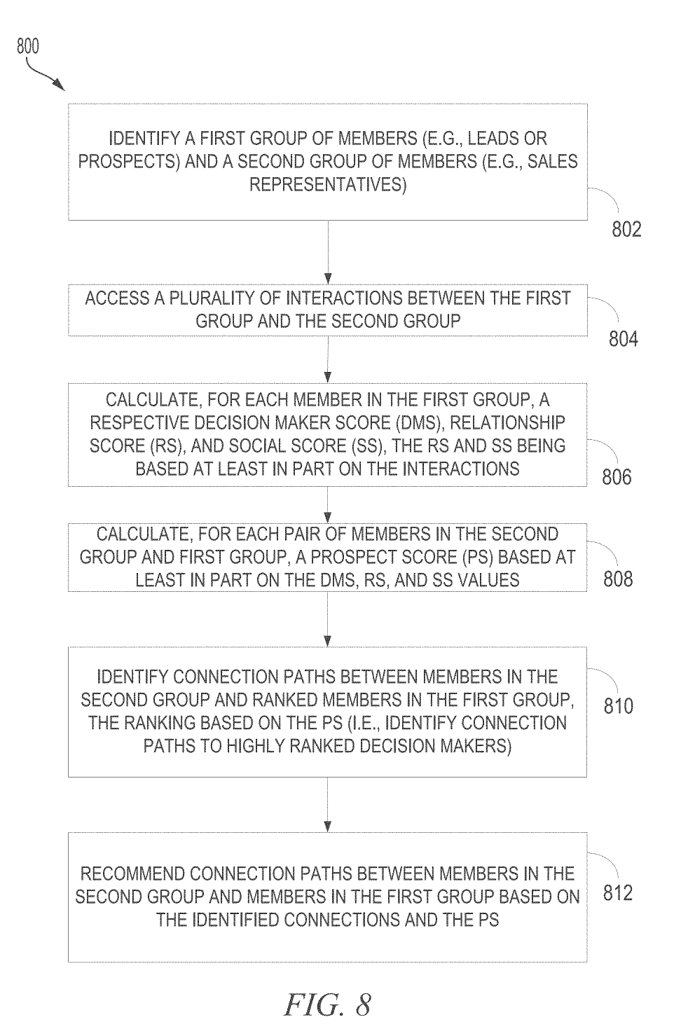

FIG. 8 is a flowchart illustrating an example method 800, in accordance with some example embodiments, for calculating PS values for a group of members of a professional social network and using the PS values to recommend connection paths between other members of the network (e.g., sales representatives) and members in the group (e.g., sales prospects). Each of the operations shown in FIG. 8 may correspond to instructions stored in a computer memory or computes-readable storage medium. In some embodiments, the method 800 described in FIG. 8 is performed by a social networking system (e.g., the social networking system 102 in FIG. 2). However, the method 800 described below can also be performed by any other suitable configuration of electronic hardware.

In some embodiments, the method 800 is performed by a social networking system (e.g., the social networking system 102 in FIG. 2) including one or more processors and memory storing one or more programs for execution by the one or more processors.

In some example embodiments, the social networking system (e.g., the social networking system 102 in FIG. 2) performs the method 800 in response to receiving a request for a list of members (e.g., lead recommendations) from a client device associated with a requesting member (e.g., a sales agent or sales representative). In some example embodiments, the received request indicates a specific organization (e.g., a target company of interest to the requesting member). In other example embodiments, the request indicates a specific number of requested members (e.g., a request for the top K leads or prospects).

At operation 802, a first group of members sales leads or prospects) and a second group of members (e.g., sales representatives) are identified. In some embodiments, operation 802 includes using a member selection module, which may be a sub-module of the application server module 204 of FIG. 2, and member profile data 216 and organization data to identify two different groups of members in response to receiving a request for information about potential lead recommendations or other ranking request for decision makers. In some example embodiments, the first group of members is potential decision makers and the second group of members is sales professionals.

In some example embodiments, at operation 802, the social networking system (e.g., the social networking system 102 in FIG. 2) identifies a first group of members (e.g., sales representatives) and second group of members (e.g., potential sales lead or sales prospects). As noted previously, when using this method 800 to determine a PS value, the first group of members are members who are potentially (or likely) decision makers within a given organization. This determination can be made based on information about an organization's structure, information about member titles, and information about past transactions, in addition to any other useful data.

In some example embodiments, operation 802 uses the social networking system (e.g., the social networking system 102 in FIG. 2) to identify a first group of members (e.g., sales prospects or sales leads) of the social networking system (e.g., the social networking system 102 in FIG. 2). In some example embodiments, the first group of members comprises members that are potential decision makers. In some example embodiments, all members are considered potential decision makers. In other example embodiments, the list of members is filtered based on data stored in the member profiles of each member. For example, members are evaluated based on work history, seniority, title, sales, purchases, social connections, and so on.

In certain example embodiments, the request identifies a particular organization (e.g., an organization such as a company that a seller is particular interested in) and the first group of members includes members from the particular organization.

In some example embodiments, operation 802 further uses the social networking system (e.g., the social networking system 102 in FIG. 2) to identify a second group of members (e.g., sales personnel or sales representatives) of the social networking system (e.g., the social networking system 102 in FIG. 2). In some example embodiments, the second group of members comprises sales professionals. In sonic example embodiments, sales professionals self-identify when registering with the social networking system (e.g., the social networking system 102 in FIG. 2). In other example embodiments, the social networking system (e.g., the social networking system 102 in FIG. 2) offers a sales related service and the social networking system (e.g., the social networking system 102 in FIG. 2) selects members who access the sales service.

Operation 802 may also include transmitting the first member group and the second member group (e.g., as member groupings) to a graph creation module that creates a bipartite graph using the first group of members (e.g., sales prospects or sales leads) and the second group of members (e.g., sales personnel or sales representatives), each on one side of the group.

At operation 804, once the first group of members (e.g., sales prospects or sales leads) and the second group of members (e.g., sales personnel or sales representatives) has been determined at operation 802, the social networking system (e.g., the social networking system 102 in FIG. 2) accesses data describing a plurality of interactions between members of the first group and members of the second group. In some example embodiments, the interactions are stored in the interaction data 222.

In some example embodiments, interactions include, but are not limited to, invitations, connections, in-system messages, follows, likes, profile views, sales, purchases, and saving member profile information as a lead. These interactions can be undirected (e.g. like a connection between two members), unidirectional (e.g., saving profile information as a sales lead), or bidirectional (e.g., messages between two members).

In some example embodiments, operation 804 uses the social networking system (e.g., the social networking system 102 in FIG. 2) accesses a plurality of interactions between the first group of members (e.g., sales prospects or sales leads) and the second group of members (e.g., sales personnel or sales representatives).

In some example embodiments, the interactions are bidirectional. Bidirectional interactions include messages, profile views, in-system messages, follows, and so on. In other example embodiments, interactions are unidirectional. Unidirectional interactions include invitations, lead saves, and so on.

In some example embodiments, the interactions are non-directional. An example of non-directional interactions is social graph connections. In some example embodiments, operation 804 further uses the social networking system (e.g., the social networking system 102 in FIG. 2) divides the plurality of interactions into a plurality of interaction types.

In some example embodiments, interaction types include at least one of invitations, social graph connects, in.-system messages (e.g., InMail messages sent within LinkedIn), profile views, follows, likes, saving information as a sales lead, sales, and purchases.

At operation 804, a plurality of interactions between the first group and the second group are accessed. For example, operation 804 may use the graph creation module to access interaction data 222 to identify one or more interactions between members of the first member group and members in the second member group. The graph creation module may use the logged interactions in the interaction data 222 as edges in the bipartite graph.

At operation 806, a respective DMS, KS, and SS value is calculated for each member in the first group. As shown in FIG. 8, the KS and SS are based at least in part on the interactions accessed at operation 804. Operation 806 may use the graph creation module to transmit the bipartite graph to the propagation module 224. The propagation module 224 then uses initial DMS values to begin the process of iteratively adjusting the initial DMS values to reflect the relative influence of the members in the first group. The DMS values will eventually reach a steady state and the propagation module 224 will use the steady state DMS values as updated DMS values.

In some example embodiments, at operation 806, the social networking system (e.g., the social networking system 102 in FIG. 2) creates a bipartite graph with the members of the first group on one side as nodes or vertices and members of the second group on the other side as vertices. Each interaction is then represented as an edge connection between two members. In some example embodiments, each interaction or edge also include the directionality of the interaction and a date at which the interaction occurred.

In some example embodiments, operation 806 includes using the social networking system (e.g., the social networking system 102 in FIG. 2) to iteratively propagate DMS values throughout the graph. For example, each member in a bipartite graph begins with an initial DMS. These initial DMS values are arrived at through a method such as analyzing that member's past work history and actions.

In some example embodiments, as part of operation 806, the first group of members (e.g., sales prospects or sales leads) is assigned a DMS, and the second group of members (who are generally sales professionals) are assigned a sales competency score (which is related to but distinct from the DMS).

In one example, while these scores are being calculated, the first group of members (e.g., sales prospects or sales leads) will be represented as being in group X={xᵢ} where i is the number of members in the first group and the first group of members will be represented as being in group Z={zᵢ}.

Further illustrating this example calculation, the social networking system (e.g., the social networking system 102 in FIG. 2) can separate the interactions into K different subgraphs and then assign a weight wₖ to each graph, such that the final score will include a weighted representation from each sub-graph. Each interaction is an edge E and may be separated into different interaction groups K such that Eₖ=eₖ₍ᵢⱼ₎, xi∈X, zⱼ∈Z}.

Edges can be undirected (eₖ₍ᵢⱼ₎), uni-directional (e_{k(i→j)}), or bi-directional (e_{k(i→j)}). In the following example, the unidirectional edges are used, but all three types of edges can be used.

Thus, in one example, the DMS for a given member of the first member group (pᵢ) and a sales competency score for a given member of the second member group (qⱼ) are given by the equations listed below:

$${p}_{i} = f ( {w}_{pc} {x}_{i} + {\sum }_{k = 1}^{K} {w}_{pk} {\sum }_{j : {e}_{k ( j \to i ) ∈ {E}_{k}}} {q}_{j} \cdot t ( j , i ) ) , \\ {q}_{j} = g ( {w}_{qc} {z}_{j} + {\sum }_{k = 1}^{K} {w}_{qk} {\sum }_{i : {e}_{k ( i \to j ) ∈ {E}_{k}}} {p}_{i} \cdot t ( i , j ) ) ,$$

In this example, w_{pc} and w_{qc} are the weights for all constant (individual) features of xᵢ and zⱼ that are not based on the bipartite graphs. In this example context, these features include profile-based features such as title, position, and seniority.

Note that the first member group may include a different number of features than the second member group. For example, different factors ma be considered when evaluating a sales person than when evaluating a member's influence. However, whatever number of features are considered, the factors are combined (e.g., using weighted average or other method) to result in a single value (e.g., xᵢ or zⱼ) that is then used in the above calculations. Furthermore, wₚₖ and W_{qk} are the weights for graph Gₖ and they measure how graph Gₖ contributes to the overall model regardless of index i or j. Also, to, t_{(j, i)} is a pre-defined transformation function for pairs (zⱼ, xᵢ). In the simplest case, t_{(j, i)} can be the count of signals zⱼ sent to xᵢ in the given time frame.

Thus, as seen above in the example formula, a single iteration for calculating the DMS for a particular member of the first member group can involve calculating a score for each interaction (based on the sales competency score qⱼ for a given member of the second member group) and combining (e.g., multiplying) it by a pre-defined transformation function for pairs to, t_{(j, i)} (e.g., a count of signals). Thus, the score for each interaction is summed for a particular interaction group K, and the summed scores for each interaction group are then summed (e.g., potential of each interaction group having its own weight wₚₖ). This sum is then added to the DMS value for all the constant factors associated with a particular member.

In some embodiments, the PS for a given member (e.g., a sales prospect), identified by a unique memberID, may be computed based on the following three metrics: DMS: [memberID, score], where the score is the DMS value for a member having memberID; RS: [sales representative, memberID, score], where the score is a numeric measure of the relationship strength the sales representative has with the member having memberID; and SS [RS multiplied by a number of connections the member has]. In certain embodiments, the member's DMS value may be calculated using the equations listed above. In an example, by using the above-noted equations, the member's DMS value may be determined to be a numeric value, e.g., 420. Also, for instance, the RS value may be a number (e.g., 350) measuring the education, career, connection, and geographic overlap the sales representative has with the member using the features described above. Continuing with this example, the SS value may be calculated as a product of the sales representative's RS value and the number of connections the member has. In this example, if the sales representative's RS value is 350 and the member has 450 connections, the SS value will be 350×450=157,500.

These three metrics, DMS (e.g., 420), RS (e.g., 350), and SS (e.g., 157,500), can then he used to produce the member's PS value. In certain embodiments, the three metrics can assigned different weights to tune PS values. After these three metrics, the DMS, RS, and SS values, have been determined based on the above-noted equations and features, a second model may be built upon these three metrics with a logistic regression algorithm. That model may then be used to produce a PS value for the member (e.g., the prospect) with respect to the sales representative. This can then be repeated for other members in the professional social network (e.g., other prospects) and the sales representative so that the respective PS values for the members may be used to rank sales prospects.

The RS value can be conceptualized as a measure of how likely a sales representative is to make sales to prospects based on relationships the representative has made with the prospects. In some embodiments, in-system messages (e.g., InMail messages sent within LinkedIn) are used as channels for sales representatives to directly contact prospects. According to these embodiments the sales representative's relationship strength with a prospect impacts the likelihood of the prospect accepting an in-system message from the representative. In certain embodiments, the RS value component of the SS value for the sales representative is based on analyzing in-system messages (e.g., InMail messages) sent by the representative and examining commonalities between the representative (e.g., the message sender) and the prospect (e.g., the message receiver) to identify the most important factors that drive message acceptance rates.

This data-driven analysis revealed the importance of the RS value, and in particular, showed that meaningful commonalities between the sales representative and the prospect (e.g., education, career, connection, and geographic overlap) increase message acceptance rate. For example, the analysis showed that sales representatives see a 46% lift in in-system message acceptance rates when having at least one commonality with a prospect versus having no commonalities. The RS value measures common connections and education overlap because the analysis also showed that having common connections and attending the same school as a prospect drove in-system message acceptance, regardless of the prospect's seniority. In particular, certain commonalities such as attending the same school, working at the same company at some point in the past, or having common connections increase a RS value because the analysis indicates that these were the strongest drivers of in-system message acceptance.

For instance, having at least one common connection with a prospect increased in-system message acceptance rates by 45%. Also, for example, attending the same school increased in-system message acceptance rates by 37%, and by 42% if the sales representative and the prospect attended the school at the same time. Further, for example, working at the same organization (e.g., a company) at some point in the past increased acceptance rates by 26%. Lastly, following at least one similar group increased acceptance rates by 18%. As a result, in embodiments, RS values are based on career and education overlap.

Additionally, RS values are based on a number of commonalities based on the analysis indicating the importance of having at least one common connection or following at least one similar group in a professional social network. The more a representative has in common with a prospect, the higher the RS value. For example, the analysis indicated that there was a 20% lift in in-system message acceptance rate when going from one to five common connections.

Embodiments using PS values based on DMS values, RS values, and SS values, which in turn are based on RS values, leverage commonalities between sales representatives and prospects in order to reach key decision makers at a target organization (e.g., a company targeted by a sales representative). Use of the PS values described herein enable representatives to reach the right decision maker within an organization, particularly when in-system messages are used as a channel to reach out to decision makers in the organization. In particular, by leveraging commonalities, embodiments improve the likelihood of a successful outreach. For example, the analysis showed that sales representatives that follow the same groups as the decision maker increased their in-system message acceptance rate by 20%. Also, the analysis showed that sales representatives who at some point in the past worked at the same company as the decision maker, saw an in-system message acceptance increase in 22%. Further, the analysis showed that sales representatives who attended the same school at the same time saw a 53% in-system message acceptance rate increase.

In some example embodiments, the social networking system (e.g., the social networking system 102 in FIG. 2) uses a computer learning model to determine the weights given to interaction groups. In some example embodiments, the model is created using a deep learning or neural network learning method. In some example embodiments, the social networking system (e.g., the social networking system 102 in FIG. 2) model uses the entire corpus of member profile information, past member interactions, and information about member influence and sales competency to create a model for generating weights.

In another example embodiment, the model is trained, using a set of training data, to generate appropriate weights using a neural network. The training data has all the input data that will be used in a live example, as well as ground truth data (e.g., data that represents the ideal output from the model). In this example, the neural network takes inputs (e.g., member profile data, message data, social graph data, work profile data, title information). Each of these inputs is given a weight and passed to a plurality of hidden nodes. The hidden nodes exchange information, also given weights, to produce an output (in this case one or more factor weights). In some example embodiments, there are several layers of hidden nodes. The model is compared to the ideal output and the weights used by the models are updated until the model produces accurate data. Once the model is trained, the model is tested using a test set of data. The model can then be used to generate the weights used in the DMS, RS, SS, and PS calculations.

In some example embodiments, operation 806 includes using the social networking system (e.g., the social networking system 102 in FIG. 2) to continue to iterate based on the above formulas until the DMS, RS, and SS (and the sales competency score) reach a steady state.

In some example embodiments, once the DMS, RS, and SS values reach a steady state, operation 806 includes using the social networking system (e.g., the social networking system 102 in FIG. 2) to update stored DMS, RS, and SS values based on the determined graph result.

At operation 808, a PS is calculated for each pair of members in the second group and first group. In the example of FIG. 8, the PS values are based at least in part on the DMS, RS, and SS values calculated at operation 806.

At operation 810, connection paths between members in the second group and ranked members in the first group are identified. As shown, the ranking at operation 810 may be based on the PS. In the example of FIG. 8, operation 810 includes identifying connection paths between members in the second group (e.g., sales agents) to highly ranked decision makers in the first group (e.g., prospects or sales leads). Operation 810 may invoke the ranking module 226, which uses the updated DMS values to generate member rankings based on an updated PS. In some example embodiments, the member rankings are also determined based on other factors in addition to the updated PS values.

At operation 812, connection paths between members in the second group and members in the first group are recommended. As shown, the recommendations may be based on the identified connections from operation 810 and the PS values calculated at operation 808. In certain embodiments, operation 812 may include presenting the recommended connection paths via user interfaces, such as, for example, the user interfaces of FIGS. 5-7.

### Software Architecture

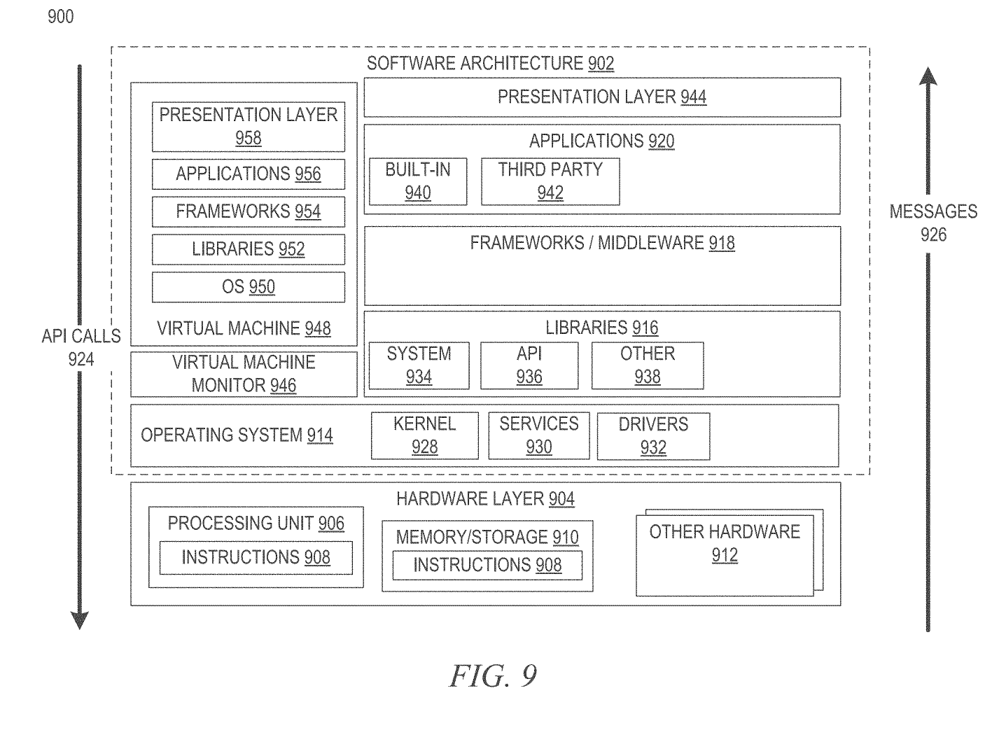

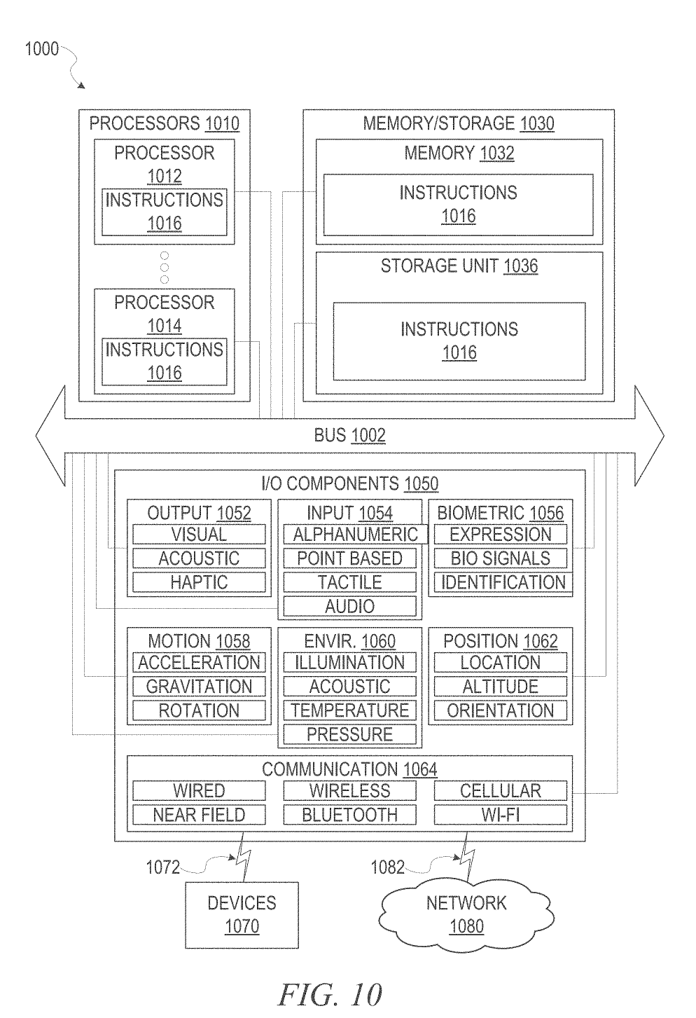

FIG. 9 is a block diagram 900 illustrating a representative software architecture 902, which may be used in conjunction with various hardware architectures herein described FIG. 9 is merely a non-limiting example of a software architecture, and it will be appreciated that many other architectures may be implemented to facilitate the functionality described herein. The software architecture 902 may be executing on hardware such as a machine 1000 of FIG. 10 that includes, among other things, processors 1010, memory/storage 1030, and I/O components 1050. A representative hardware layer 904 is illustrated and can represent, for example, the machine 1000 of FIG. 10. The representative hardware layer 904 comprises one or more processing units 906 having associated executable instructions 908. The executable instructions 908 represent the executable instructions of the software architecture 902, including implementation of the methods, modules, user interfaces, and so forth of FIGS. 1-8. The hardware layer 904 also includes memory and/or storage modules 910, which also have the executable instructions 908. The hardware layer 904 may also comprise other hardware 912, which represents any other hardware of the hardware layer 904, such as the other hardware illustrated as part of the machine 1000.

In the example architecture of FIG. 9, the software architecture 902 may be conceptualized as a stack of layers where each layer provides particular functionality. For example, the software architecture 902 may include layers such as an operating system 914, libraries 916, frameworks/middleware 918, applications 920, and a presentation layer 944. Operationally, the applications 920 and/or other components within the layers may invoke API calls 924 through the software stack and receive responses, returned values, and so forth, illustrated as messages 926, in response to the API calls 924. The layers illustrated are representative in nature and not all software architectures have all layers. For example, some mobile or special-purpose operating systems may not provide a layer of frameworks/middleware 918, while others may provide such a layer. Other software architectures may include additional or different layers.

The operating system 914 may manage hardware resources and provide common services. The operating system 914 may include, for example, a kernel 928, services 930, and drivers 932. The kernel 923 may act as an abstraction layer between the hardware and the other software layers. For example, the kernel 928 may be responsible for memory management, processor management (e.g., scheduling), component management, networking, security settings, and so on. The services 930 may provide other common services for the other software layers. The drivers 932 may be responsible for controlling or interfacing with the underlying hardware. For instance, the drivers 932 may include display camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 916 may provide a common infrastructure that may be utilized by the applications 920 and/or other components and/or layers. The libraries 916 typically provide functionality that allows other software modules to perform tasks in an easier fashion than by interfacing directly with the underlying operating system 914 functionality (e.g., kernel 928, services 930, and/or drivers 932). The libraries 916 may include system libraries 934 (e.g., C standard library) that may provide functions such as memory allocation functions, string manipulation functions, mathematic functions, and the like. In addition, the libraries 916 may include API libraries 936 such as media libraries (e.g., libraries to support presentation and manipulation of various media formats such as MPEG4, H.264, MP3, AAC, AMR, JPG, and PNG), graphics libraries (e.g., an OpenUL framework that may be used to render 2D and 3D graphic content on a display), database libraries (e.g., SQLite that may provide various relational database functions), web libraries (e.g., WebKit that may provide web browsing functionality), and the like. The libraries 916 may also include a wide variety of other libraries 938 to provide many other APIs to the applications 920 and other software components/modules.

The frameworks 918 (also sometimes referred to as middleware) may provide a higher-level common infrastructure that may be utilized by the applications 920 and/or other software components/modules. For example, the frameworks 918 may provide various graphic user interface (GUI) functions, high-level resource management, high-level location services, and so forth. The frameworks 918 may provide a broad spectrum of other APIs that may be utilized by the applications 920 and/or other software components/modules, some of which may be specific to a particular operating system or platform.

The applications 920 include built-in applications 940 and/or third-party applications 942. Examples of representative built-in applications 940 may include, but are not limited to, a contacts application, a browser application, a book reader application, a location application, a media application, a messaging application, and/or a game application. The third-party, applications 942 may include any of the built-in applications 940 as well as a broad assortment of other applications. In a specific example, the third-party application 942 (e.g., an application developed using the Android™ or iOS™ software development kit (SDK) by an entity other than the vendor of the particular platform) may be mobile software running on a mobile operating system such as iOS™, Android™, Windows® Phone, or other mobile operating systems. In this example, the third-party application 942 may invoke the API calls 924 provided by the mobile operating system such as the operating system 914 to facilitate functionality described herein.

The applications 920 may utilize built-in operating system 914 functions kernel 928, services 930, and/or drivers 932), libraries 916 (e.g., system libraries 934, API libraries 936, and other libraries 938), and frameworks/middleware 918 to create user interfaces to interact with users of the system. Alternatively, or additionally, in some systems, interactions with a user may occur through a presentation layer, such as the presentation layer 944. In these systems, the application/module “logic” can be separated from the aspects of the application/module that interact with a user.

Some software architectures utilize virtual machines. In the example of FIG. 9, this is illustrated by a virtual machine 948. A virtual machine creates a software environment where applications/modules can execute as if they were executing on a hardware machine (such as the machine 1000 of FIG. 10, for example). A virtual machine is hosted by a host operating system (e.g., operating system 914 in FIG. 9) and typically, although not always, has a virtual machine monitor 946, which manages the operation of the virtual machine 948 as well as the interface with the host operating system (e.g., operating system 914). A software architecture executes within the virtual machine 948, such as an operating system 950, libraries 952, frameworks/middleware 954, applications 956, and/or a presentation layer 958. These layers of software architecture executing within the virtual machine 948 can be the same as corresponding layers previously described or may be different.

### Example Architecture and Machine-Readable Medium

FIG. 10 is a block diagram illustrating components of a machine 1000, according to some example embodiments, able to read instructions from a machine-readable medium (e.g., a machine-readable storage medium) and perform any one or more of the methodologies discussed herein. Specifically, FIG. 10 shows a diagrammatic representation of the machine 1000 in the example form of a computer system, within which instructions 1016 (e.g., software, a program, an application, an apples, an app, or other executable code) for causing the machine 1000 to perform any one or more of the methodologies discussed herein may be executed. The instructions 1016 transform the general, non-programmed machine into a particular machine programmed to carry out the described and illustrated functions in the manner described. In alternative embodiments, the machine 1000 operates as a standalone device or may be coupled (e.g., networked) to other machines. In a networked deployment, the machine 1000 may operate in the capacity of a server machine or a client machine in a server-client network environment, or as a peer machine in a peer-to-peer (or distributed) network environment. The machine 1000 may comprise, but not be limited to, a server computer, a client computer, a PC, a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 1016, sequentially or otherwise, that specify actions to be taken by the machine 1000. Further, while only a single machine 1000 is illustrated, the term “machine” shall also be taken to include a collection of machines 1000 that individually or jointly execute the instructions 1016 to perform any one or more of the methodologies discussed herein.

The machine 1000 may include processors 1010, memory/storage 1030, and I/O components 1050. Which may be configured to communicate with each other such as via a bus 1002. In an example embodiment, the processors 1010 (e.g., a Central Processing Unit (CPU), a Reduced Instruction Set Computing (RISC) processor, a Complex Instruction Set Computing (CISC) processor, a Graphics Processing Unit (CPU), a Digital Signal Processor (DSP), an application-specific integrated circuit (ASIC), a Radio-Frequency integrated Circuit (RFIC), another processor, or any suitable combination thereof) may include, for example, a processor 1012 and a processor 1014 that may execute the instructions 1016. The term “processor” is intended to include multi-core processors that may comprise two or more independent processors (sometimes referred to as “cores”) that may execute instructions contemporaneously. Although FIG. 10 shows multiple processors 1010, the machine 1000 may include a single processor with a single core, a single processor with multiple cores (e.g., a multi-core processor), multiple processors with a single core, multiple processors with multiples cores, or any combination thereof.

The memory/storage 1030 may include a memory 1032, such as a main memory, or other memory storage, and a storage unit 1036, both accessible to the processors 1010 such as via, the bus 1002. The storage unit 1036 and memory 1032 store the instructions 1016 embodying any one or more of the methodologies or functions described herein. The instructions 1016 may also reside, completely or partially, within the memory 1032, within the storage unit 1036, within at least one of the processors 1010 (e.g., within the processor's cache memory), or any suitable combination thereof, during execution thereof by the machine 1000. Accordingly, the memory 1032, the storage unit 1036, and the memory of the processors 1010 are examples of machine-readable media.

As used herein, “machine-readable medium” means a device able to store instructions and data temporarily or permanently and may include, but is not limited to, random-access memory (RAM), read-only memory (ROM), buffer memory, flash memory, optical media, magnetic media, cache memory, other types of storage (e.g., Erasable Programmable Read-Only Memory (EEPROM)), and/or any suitable combination thereof. The term “machine-readable medium” should be taken to include a single medium or multiple media (e.g., a centralized or distributed database, or associated caches and servers) able to store the instructions 1016. The term “machine-readable medium” shall also be taken to include any medium, or combination of multiple media, that is capable of storing instructions (e.g., instructions 1016) for execution by a machine (e.g., machine 1000), such that the instructions, when executed by one or more processors of the machine (e.g., processors 1010), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 1050 may include a wide variety of components to receive input, provide output, produce output, transmit information, exchange information, capture measurements, and so on. The specific I/O components 1050 that are included in a particular machine will depend on the type of machine. For example, portable machines such as mobile phones will likely include a touch input device or other such input mechanisms, while a headless server machine will likely not include such a touch input device. It will be appreciated that the I/O components 1050 may include many other components that are not shown in FIG. 10. The I/O components 1050 are grouped according to functionality merely for simplifying the following discussion and the grouping is in no way limiting. In various example embodiments, the PO components 1050 may include output components 1052 and input components 1054.

The output components 1052 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1054 may include alphanumeric input components (e.g., a keyboard, a touch screen configured to receive alphanumeric input, a photo-optical keyboard, or other alphanumeric input components), point-based input components (e.g., a mouse, a touchpad, trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the PO components 1.050 may include biometric components 1056, motion components 1058, environmental components 1060, or position components 1062, among a wide array of other components. For example, the biometric components 1056 may include components to detect expressions (e.g., hand expressions, facial expressions, vocal expressions, body gestures, or eye tracking), measure biosignals blood pressure, heart rate, body temperature, perspiration, or brain waves), identify a person (e.g., voice identification, retinal identification, facial identification, fingerprint identification, or electroencephalogram-based identification), and the like. The motion components 1058 may include acceleration sensor components (e.g., accelerometer), gravitation sensor components, rotation sensor components (e.g., gyroscope), and so forth.

The environmental components 1060 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 1062 may include location sensor components (e.g., a Global Position System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The 1/0 components 1050 may include communication components 1064 operable to couple the machine 1000 to a network 1080 or devices 1070 via a coupling 1082 and a coupling 1072, respectively. For example, the communication components 1064 may include a network interface component or other suitable device to interface with the network 1080. In further examples, the communication components 1064 may include wired communication components, wireless communication components, cellular communication components, Near Field Communication (NRC) components, Bluetooth® components (e.g., Bluetooth® Low Energy), Wi-Fi® components, and other communication components to provide communication via other modalities. The devices 1070 may be another machine or any of a wide variety of peripheral devices (e.g., a peripheral device coupled via a USB).

Moreover, the communication components 1064 may detect identifiers or include components operable to detect identifiers. For example, the communication components 1064 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, PDF417, Ultra Code, UCC RSS-2D bar code, and other optical codes), or acoustic detection components (e.g., microphones to identify tagged audio signals). In addition, a variety of information may be derived via the communication components 1064, such as location via Internet Protocol (IP) geolocation, location via signal triangulation, location via detecting an NFC beacon signal that may indicate a particular location, and so forth.

### Transmission Medium

In various example embodiments, one or more portions of the network 1080 may be an ad hoc network, an intranet, an extranet, a virtual private network (VPN), a local area network (LAN), a wireless LAN (WLAN), a WAN, a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, the network 1080 or a portion of the network 1080 may include a wireless or cellular network and the coupling 1082 may be a Code Division Multiple Access (CDMA) connection, a Global System for Mobile communications (GSM) connection, or another type of cellular or wireless coupling. in this example, the coupling 1082 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third-Generation Partnership Project (3GPP) including 3G, fourth-generation wireless (4G) networks, Universal Mobile Telecommunications System (UMTS), High-Speed Packet Access (HSPA), Worldwide interoperability for Microwave Access (WiMAX), Long-Term Evolution (LTE) standard, other specifications and standards defined by various standard-setting organizations other long-range protocols, or other data transfer technology.

The instructions 1016 may be transmitted or received over the network 1080 using a transmission medium via a network interface device (e.g., a network interface component included in the communication components 1064) and utilizing any one of a number of well-known transfer protocols (e.g., HTTP). Similarly, the instructions 1016 may be transmitted or received using a transmission medium via the coupling 1072 (e.g., a peer-to-peer coupling) to the devices 1070. The term ‘transmission medium’ shall be taken to include any intangible medium that is capable of storing, encoding, or carrying the instructions 1016 for execution by the machine 1000, and includes digital or analog communications signals or other intangible media to facilitate communication of such software.

### Language

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term or may be construed in either an inclusive or an exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

What is claimed is:

1. A computer-implemented method performed at a social networking system, using at least one computer processor, the method comprising:
identifying a first group of members of the social networking system;
identifying a second group of members of the social networking system;
accessing a plurality of interactions between the first group of members and the second group of members;
calculating, for each member in the first group, a respective decision maker score (DMS);
calculating, for each pair of members in the second group and first group, a prospect score (PS) based on the DMS of a member in the first group, a relationship score (RS) measuring commonalities between the member of the first group and a member of the second group, and a social score (SS), the RS and the SS being based at least in pan on the plurality of interactions;
identifying connection paths between members in the second group and ranked members in the first group, the ranking being based on the PS values; and
causing a display, in a user interface of the social networking system, of a recommendation of one or more connection paths recommending connection paths between members in the second group and members in the first group based on the identified connections and the PS values.

2. The method of claim 1, wherein the second group of members includes sales professionals.

3. The method of claim 2, wherein the first group of members includes members of a specific organization targeted by the sales professionals.

4. The method of claim 1, wherein calculating the respective DMS values comprises:
creating a bipartite graph of the first group of members and the second group of members using the members as nodes of the graph and interactions between the members as edges in the graph and identifying an initial score for each member in the first group of members and the second group of members; and
based on the bipartite graph, iteratively propagating DMS values between the first group of members and the second group of members based on the accessed interactions until the DMS values reach a steady state.

5. The method of claim 4, wherein each interaction has an associated interaction date and interactions are used to propagate scores through the bipartite graph based on the associated interaction date.

6. The method of claim 1, wherein the interactions are one or more of bidirectional; unidirectional; and non-directional.

7. The method of claim 1, wherein the interactions indicate interaction types, the interaction types including at least one of invitations, social graph connects, in-system messages, profile views, follows, likes, saving information as a sales lead, sales, and purchases.

8. The method of claim 1, further comprising:
receiving a request for a list of members with updated PS values from a client device associated with a requesting member in the second group of members.

9. The method of claim 8, further comprising:
after updating the PS values, ranking the list of members in the first group of members based on the updated PS values.

10. The method of claim 8, wherein recommending the connection paths comprises:
selecting one or more members based on the member rankings; and
transmitting the selected one or more members to the client device associated with the requesting member for display.

11. The method of claim 8, wherein the received request indicates a specific organization targeted by the requesting member, and wherein the members identified for the first group of members are associated with the specific organization.

12. A social networking system comprising:
a processor;
a storage device;
a propagation module;
a decision maker and prospect scoring module;
a best-in-path module;
a lead recommendation module; and
a memory device holding an instruction set executable on the processor to cause the social networking system to perform operations comprising:
identifying, by the propagation module, a first group of members of the social networking system;
identifying, by the propagation module, a second group of members of the social networking system;
accessing, by the propagation module, from the storage device, a plurality of interactions between the first group of members and the second group of members;
calculating, by the decision maker and prospect scoring module, for each member in the first group, a respective decision maker score (DMS);
calculating, by the decision maker and prospect scoring module, for each pair of members in the second group and first group, a prospect score (PS) based on the DMS of a member in the first group, a relationship score (RS) measuring commonalities between the member of the first group and a member of the second group, and a social score (SS), the RS and the SS being based at least in part on the plurality of interactions;
identifying, by the best-in-path module, connection paths between members in the second group and ranked members in the first group, the ranking being based on the PS values; and
causing a display, by the lead recommendation module, in a user interface of the social networking system, of a recommendation of one or more connection paths recommending connection paths between members in the second group and members in the first group based on the identified connections and the PS values.

13. The system of claim 12, wherein the second group of members includes sales professionals, and wherein the first group of members includes members of a specific organization targeted by the sales professionals.

14. The system of claim 12, further comprising a user interface module, the operations further comprising:
receiving, by the user interface module, a request for a list of members with updated PS values from a client device associated with a requesting member in the second group of members.

15. The system of claim 14, the operations further comprising:
after updating the PS values, ranking, by the best-in-path module, the list of members in the first group of members based on the updated PS values.

16. The system of claim 14, wherein recommending the connection paths comprises:
selecting, by the lead recommendation module, one or more members based on the member rankings; and
transmitting, by the user interface module, the selected one or more members to the client device associated with the requesting member for display.

17. A non-transitory computer-readable medium storing executable instructions thereon, which, when executed by a processor, cause the processor to perform operations including:
identifying a first group of members of a social networking system;
identifying a second group of members of the social networking system;
accessing a plurality of interactions between the first group of members and the second group of members;
calculating, for each member in the first group, a respective decision maker score (DMS);
calculating, for each pair of members in the second group and first group, a prospect score (PS) based on the DMS of a member in the first group, a relationship score (RS) measuring commonalities between the member of the first group and a member of the second group, and a social score (SS), the RS and the SS being based at least in part on the plurality of interactions;
identifying connection paths between members in the second group and ranked members in the first group, the ranking being based on the PS values; and
causing a display, in a user interface of the social networking system, of a recommendation of one or more connection paths recommending connection paths between members in the second group and members in the first group based on the identified connections and the PS values.

18. The non-transitory computer-readable storage medium of claim 17, wherein the second group of members includes sales professionals, and wherein the first group of members includes members of a specific organization targeted by the sales professionals.

19. The non-transitory computer-readable storage medium of claim 17, wherein the interactions are one or more of bidirectional; unidirectional; and non-directional.

20. The non-transitory computer-readable storage medium of claim 17, wherein the interactions indicate interaction types, the interaction types including at least one of invitations, social graph connects, in-system messages, profile views, follows, likes, saving information as a sales lead, sales, and purchases.
